(19) United States
(12) Patent Application Publication
(10) Pub. No.: US 2011/0057786 A1
(43) Pub. Date: Mar. 10, 2011

(54) Alert braking system

(76) Inventor: Eugene Giddens, Camden, DE (US)

(21) Appl. No.: 12/807,443

(22) Filed: Sep. 3, 2010

Related U.S. Application Data
(60) Provisional application No. 61/276,348, filed on Sep. 10, 2009.

(51) Int. Cl. B60Q 1/44

(52) U.S. Cl. 340/479

(57) ABSTRACT

The present invention to provides an improved brake light system which provides increasing illumination with increased braking intensity. The ALERT BRAKING System is a brake light system for automotive vehicles which comprises a speed sensing device, a third brake light mounted on the rear window or either tail light, and interconnecting wiring. This third brake light actually comprises of a series of individual light bulbs, horizontally positioned in rows down the surface of the light assembly. The speed sensor is connected to a logic circuit which, in turn, is connected to the vehicle's computer. In an alternative embodiment, the ALERT BRAKING System can be programmed to be activated at predetermined speeds, with the flashing motion of the lights deactivated once the vehicle has slowed to near stop.

### CLAIM OF PRIORITY

This patent application claims priority under 35 USC 119(e) (1) from U.S. Provisional Patent Application Ser. No. 61/276,348 filed Sep. 10, 2009, of common inventorship herewith entitled, “ABS Additional Brake Light System.”

### FIELD OF THE INVENTION

The present invention pertains to the field of automotive accessories and more specifically to the field of brake light systems for vehicles.

### BACKGROUND OF THE INVENTION

The prior art has put forth several designs for brake light systems for vehicles. Among these are:

U.S. Pat. No. 6,351,211 to W. Brooks Bussard describes a brake warning method and system comprising a warning signal in the form of a strobe light which lights faster and brighter according to how hard the driver applies the brakes.

U.S. Pat. No. 6,753,769 to Lawrence T. Elliott describes a progressive slow-stop signaling system which energizes a plurality of yellow and red lamps mounted on the rear of a vehicle warning oncoming vehicles of impending changes in the speed of the vehicle.

U.S. Pat. No. 7,002,459 to Fernando J. de la Fuente Escandon describes an integral vehicle brake indicator comprises an electronic system for processing actual speed signals and engine revolutions and a plurality of lights which light up proportionally to the actual speed loss of the vehicle.

None of these prior art references describe the present invention.

### SUMMARY OF THE INVENTION

It is an object of the present invention to provide an improved brake light system which provides increasing illumination with increased braking intensity.

### BRIEF DESCRIPTION OF THE DRAWINGS

FIG. 1 shows the present invention with low illumination actuated by moderate braking.

FIG. 2 shows the present invention with medium illumination actuated by accelerated braking.

FIG. 3 shows the present invention with high illumination actuated by aggressive braking.

FIG. 4 shows an alternative embodiment of the present invention showing indicator lights at the corners of the rear window.

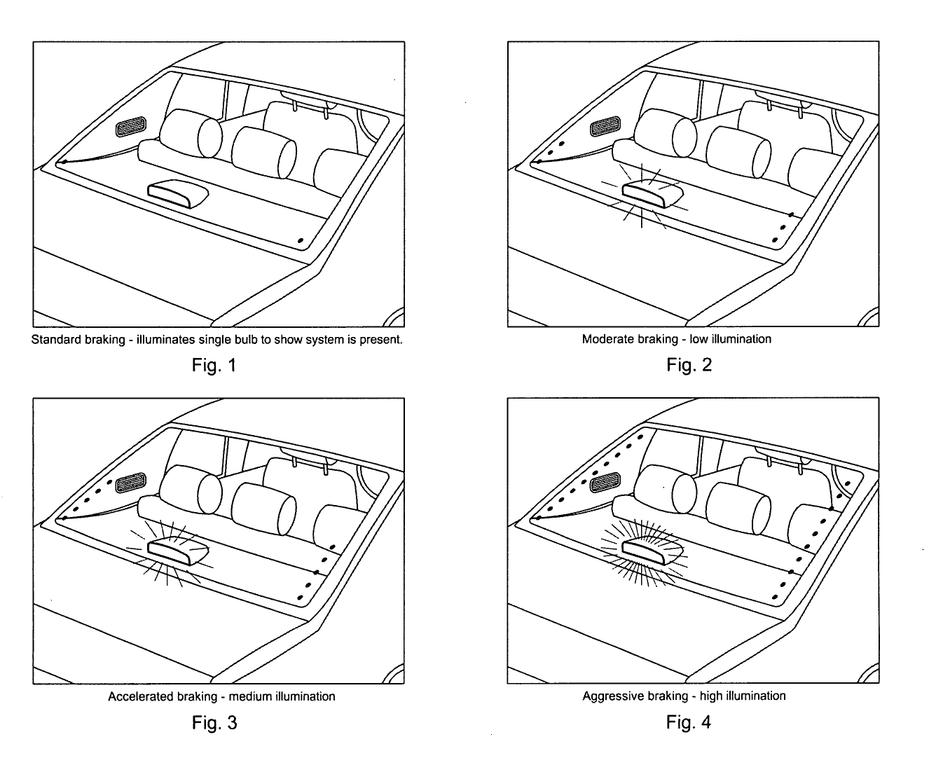

### DETAILED DESCRIPTION OF THE INVENTION

With the increase of number of automobiles, the concern for safety devices to be incorporated into the design of automobiles has increased. However, as the number of roads, cars and drivers multiplied, so did the number of automobile accidents, until the point that the federal government determined a need to require automobile manufacturers to begin designing safer cars. While safety belts, windshield wipers and turn signals were crucial in improving vehicle safety, one of the most important safety features mandated by the government is vehicle brake lights. Designed to alert motorists behind a vehicle if the driver is slowing or stopping, properly functioning brake lights are a crucial factor in preventing rear end collisions. While there is little dispute that brake lights are a crucial safety element of any vehicle, there are drawbacks associated with their use. Specifically, standard automobile brake lights operate in either ‘on’ or ‘off, indicating only that the drivers’ foot is either on or off the brake pedal. The drivers of vehicles behind any given car have no way of differentiating if the car ahead is slowing down, coming to a stop or ‘riding the brakes’, without correlation of the visual brake light signal with existing circumstances. The time required to correlate and assess this information may not always be enough to avoid an accident, particularly in emergency or panic braking situations which can unexpectedly arise. When driving along a road or busy highway, a car which is braking ahead of another car may be interpreted to be stopping when, in fact, that car may only be slowing down.

Conversely, if the driver ahead unexpectedly stops, the driver of the vehicle behind that person may have assumed the vehicle ahead was simply slowing down. As a result of this misinterpretation of intent, a collision between the vehicles may occur. Because standard brake lights do not distinguish between sudden, intense braking, or slow, casual, braking, many accidents take place which may have been avoidable if brake lights conveyed more detailed information.

Driving is too serious to be basing one's decisions on interpretation of ambiguous signals. Motorists need something more definite to be fully cognizant of the braking intent of the driver in the vehicle ahead of them, whether the driver is braking for a gradual stop, a sudden stop, or merely slowing down. Having recognized the need for a brake light system which would visually alert other drivers of the amount of braking force being applied, how fast a vehicle was being stopped, the present invention, hereinafter referred to as the Alert Braking System, was developed.

The Alert Braking System is a brake light system for automotive vehicles which comprises a speed sensing device, a third brake light mounted on the rear window or either tail light, and interconnecting wiring. This third brake light actually comprises of a series of individual light bulbs, horizontally positioned in rows down the surface of the light assembly. The speed sensor is connected to a logic circuit which, in turn, is connected to the vehicle's computer.

In an alternative embodiment, the Alert Braking System can be programmed to be activated at predetermined speeds, with the flashing motion of the lights deactivated once the vehicle has slowed to near stop. Whenever a vehicle was traveling at a fairly high speed and the driver applied pressure to the brakes, the speed sensor sends a signal to the computer which activates the Alert Braking System, illuminating the lower brake lights in the assembly. The speed of the vehicle and the amount of pressure applied to the brakes determine the number of lights and the height of the illuminated lights to advise motorists to the rear how fast a vehicle was slowing.

The Alert Braking System can be manufactured as an aftermarket product to be installed on existing vehicles. Alternatively, the Alert Braking System can be incorporated into the design of newly manufactured automobiles. Many accidents are caused by driver's not being aware of another driver's intent when braking and the Alert Braking System will greatly reduce the number of these types of accidents. The safety benefits afforded by the Alert Braking System can be beneficially used on cars, trucks, and utility vehicles, a huge potential market.

It should be noted that placement of the indicator lights can be a variety of places. For example, the lights can be placed on the rear bumper, back window, or in another location on the back of the vehicle.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An additional brake light system for a vehicle having a computer, comprising a speed sensing device, a third brake light mounted on the rear window or each tail light, and interconnecting wiring, wherein the third brake light comprises of a series of individual light bulbs, horizontally positioned in rows along the surface of the light assembly and wherein the speed sensing device is connected to a logic circuit which, in turn, is connected to the vehicle's computer.

2. The system of claim 1 wherein the system is programmed to be activated at predetermined speeds, having a flashing motion of the lights deactivated when the vehicle has slowed to near stop.

3. The system of claim 2, wherein the speed sensing device sends a signal to the computer which activates the system, illuminating the lower brake lights in the assembly when a vehicle is traveling at a high speed and the driver applies pressure to the brakes.

4. The system of claim 1 wherein the system is manufactured as an aftermarket product to be installed on existing vehicles.

5. The system of claim 1 wherein the system is incorporated into the design of newly manufactured automobiles.

6. The system of claim 2 wherein the placement of the indicator lights are placed on the rear bumper, back window, or in another location on the back of the vehicle.
